(19) United States
(12) Patent Application Publication
(10) Pub. No.: US 2025/0379342 A1
(43) Pub. Date: Dec. 11, 2025

(54) Switchable Battery Assembly

(71) Applicant: Auston Cohen, Palmdale, CA (US)

(72) Inventor: Auston Cohen, Palmdale, CA (US)

(21) Appl. No.: 18/737,243

(22) Filed: Jun. 7, 2024

(51) Int. Cl. H01M 50/574; B60R 16/033; H01M 50/533; H01M 50/55; H02J 7/00

(52) U.S. Cl. CPC H01M 50/574; H01M 50/533; H01M 50/55; H02J 7/0063; B60R 16/033; H01M 2220/20

(57) ABSTRACT

A switchable battery assembly includes a battery that has a positive terminal and a negative terminal and a plurality of chemical cells positioned within the battery. The positive terminal is in continuous electrical communication with the plurality of chemical cells. The negative terminal is inhibited from is in electrical communication with the plurality of chemical cells. A switching unit is movably integrated into the battery. The switching unit is positionable in an on position to actuate the battery into a live condition for supplying electrical current to an electrical circuit. The switching unit is positionable in an off position to inhibit the battery from supplying electrical current to the electrical circuit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to battery devices and more particularly pertains to a new battery device for turning a battery on and off. The device includes a battery and a switching unit that is movably integrated into the battery. The switching unit includes a lock which receives a key for manipulating the switching unit between an on position and an off position. The battery is actuated into a live condition when the switching unit is in the on position and the battery is actuated into a dead condition when the switching unit is in the off position.

### (2) Description of Related Art Including Information Disclosed Under 37 CFR 1.97 and 1.98

The prior art relates to battery devices including a variety of battery switching devices which each includes a battery and an externally mounted switching unit for removing the battery from electrical communication with an electrical circuit. In no instance does the prior art disclose a battery that includes a switching unit that is a unitary structure of the battery to facilitate the battery to be installed in any vehicle without making modifications to the vehicle.

### BRIEF SUMMARY OF THE INVENTION

An embodiment of the disclosure meets the needs presented above by generally comprising a battery that has a positive terminal and a negative terminal and a plurality of chemical cells positioned within the battery. The positive terminal is in continuous electrical communication with the plurality of chemical cells. The negative terminal is inhibited from is in electrical communication with the plurality of chemical cells. A switching unit is movably integrated into the battery. The switching unit is positionable in an on position to actuate the battery into a live condition for supplying electrical current to an electrical circuit. The switching unit is positionable in an off position to inhibit the battery from supplying electrical current to the electrical circuit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a switchable battery assembly according to an embodiment of the disclosure.

FIG. 2 is a front view of an embodiment of the disclosure.

FIG. 3 is a right side view of an embodiment of the disclosure.

FIG. 4 is a top view of an embodiment of the disclosure.

FIG. 5 is a cross sectional view taken along line 5-5 of FIG. 4 of an embodiment of the disclosure showing a switching unit in an off position.

FIG. 5A is a cross sectional view taken along line 5-5 of FIG. 4 of an embodiment of the disclosure showing a switching unit in an on position.

FIG. 6 is a perspective in-use view of an embodiment of the disclosure.

FIG. 7 is a cross sectional view taken along line 7-7 of FIG. 2 of an embodiment of the disclosure.

### DETAILED DESCRIPTION OF THE INVENTION

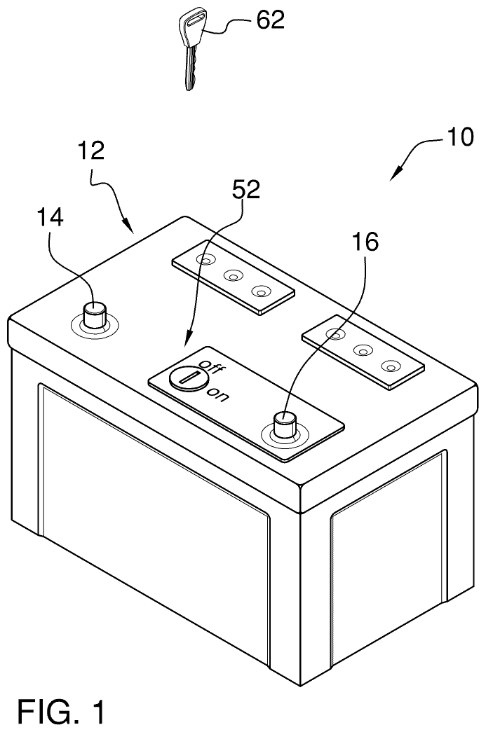

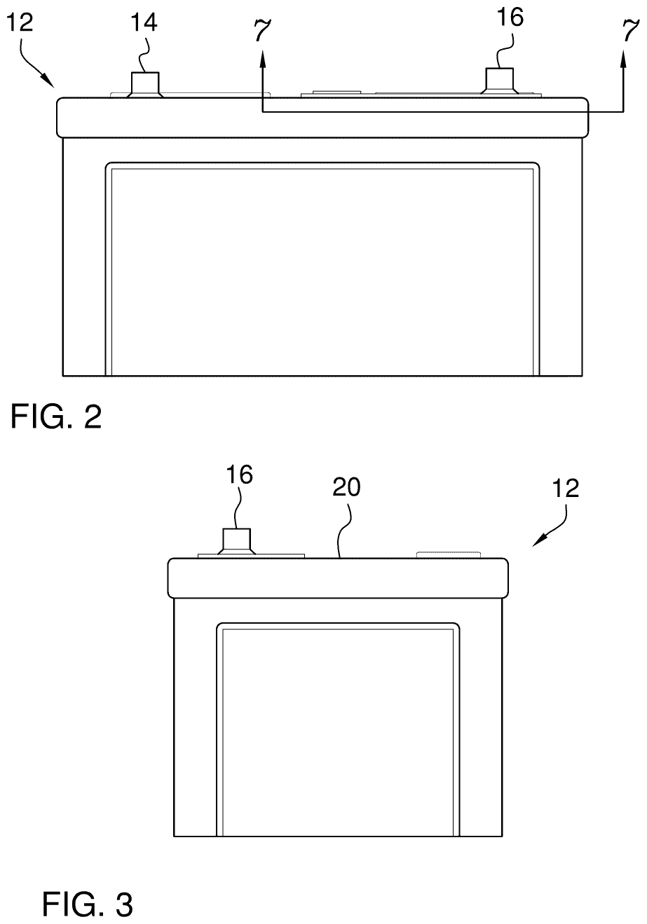

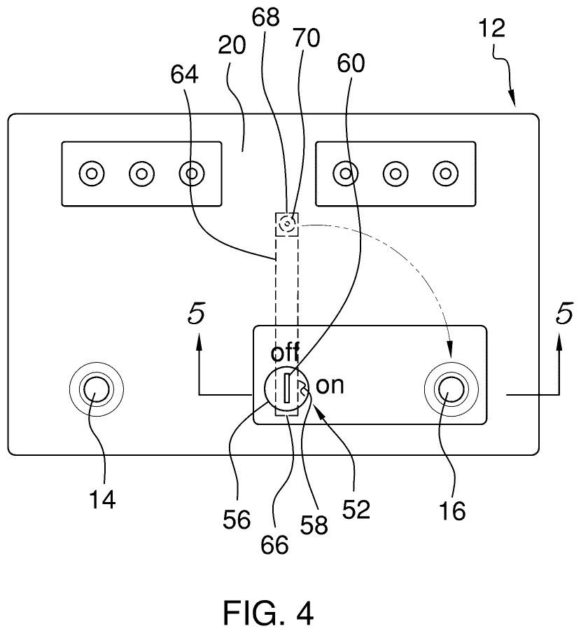

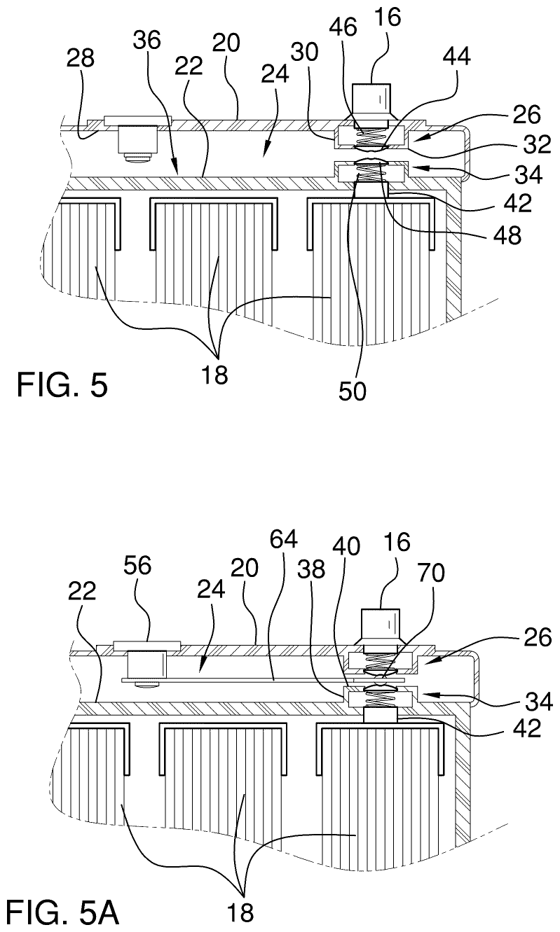

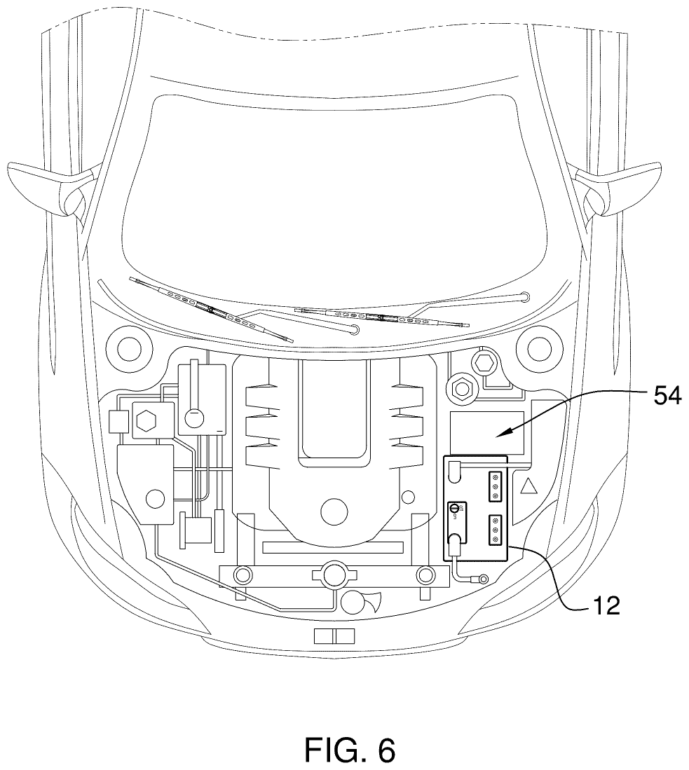

With reference now to the drawings, and in particular to FIGS. 1 through 7 thereof, a new battery device embodying the principles and concepts of an embodiment of the disclosure and generally designated by the reference numeral 10 will be described.

As best illustrated in FIGS. 1 through 7, the switchable battery assembly 10 generally comprises a battery 12 that has a positive terminal 14, a negative terminal 16 and a plurality of chemical cells 18 positioned within the battery 12. The positive terminal 14 is in continuous electrical communication with the plurality of chemical cells 18 and the negative terminal 16 is inhibited from is in electrical communication with the plurality of chemical cells 18. The battery 12 may be a 12.0 volt vehicle battery that is intended to be installed in a vehicle such as a passenger vehicle, a recreational vehicle or any other type of motorized vehicle that relies on battery power for starting the vehicle.

The battery 12 has a top wall 20 and each of the positive terminal 14 and the negative terminal 16 is disposed on the top wall 20. The battery 12 has a dividing wall 22 that is spaced from the top wall 20 to define a switch space 24 between the dividing wall 22 and the top wall 20 and each of the chemical cells 18 is positioned beneath the dividing wall 22. The battery 12 has a first housing 26 that is integrated into a bottom surface 28 of the top wall 20 and the first housing 26 has an outer wall 30 extending downwardly from the bottom surface 28 and a lower wall 32 spaced from the bottom surface 28. The battery 12 has a second housing 34 is integrated into a top surface 36 of the dividing wall 22 and the second housing 34 has an exterior wall 38 extending upwardly from the top surface 36 and an upper wall 40 spaced from the top surface 36. The first housing 26 is aligned with the second housing 34 to define a contact space 41 between the lower wall 32 of the first housing 26 and the upper wall 40 of the second housing 34. Additionally, the battery 12 may be manufactured in a wide variety of dimensions to facilitate the battery 12 to be installed in a wide range of vehicles.

A negative contact 42 is electrically coupled to a respective one of the plurality of chemical cells 18 and the negative contact 42 extends through the dividing wall 22. The negative contact 42 is comprised of an electrically conductive material. A first contact 44 is movably integrated into the lower wall 32 of the first housing 26 and the first contact 44 is comprised of an electrically conductive material. A first spring 46 is positioned within the first housing 26 and the first spring 46 extends between the negative terminal 16 and the first contact 44. Furthermore, the first spring 46 is comprised of an electrically conductive material thereby facilitating electrical communication between the first contact 44 and the negative terminal 16. The first spring 46 biases the first contact 44 away from the negative terminal 16.

A second contact 48 is movably integrated into the upper wall 40 of the second housing 34 and the second contact 48 is comprised of an electrically conductive material. A second spring 50 is positioned within the second housing 34 and the second spring 50 extends between the negative contact 42 associated with the plurality of chemical cells 18 and the second contact 48. The second spring 50 is comprised of an electrically conductive material thereby facilitating electrical communication between the second contact 48 and the negative contact 42 associated with the plurality of chemical cells 18. The second spring 50 biases the second contact 48 away from the negative contact 42 associated with the plurality of chemical cells 18.

A switching unit 52 is provided and the switching unit 52 is movably integrated into the battery 12. The switching unit 52 is positionable in an on position thereby facilitating electrical communication between the negative terminal 16 and the plurality of chemical cells 18 thereby actuating the battery 12 into a live condition to supply electrical current to an electrical circuit 54. Conversely, the switching unit 52 is positionable in an off position thereby inhibiting electrical communication between the negative terminal 16 and the plurality of chemical cells 18 thereby actuating the battery 12 into a dead condition to inhibit the battery 12 from supplying electrical current to the electrical circuit 54. The electrical circuit 54 may comprise an electrical system of the vehicle in which the battery 12 is positioned.

The switching unit 52 comprises a lock 56 that is movably integrated into the top wall 20 of the battery 12 and the lock 56 has an exposed surface 58 with respect to the top wall 20. The lock 56 has a keyhole 60 which is integrated into the exposed surface 58 thereby facilitating the keyhole 60 to insertably receive a key 62 for rotating the lock 56 between a first position and a second position. In this way only an authorized user can manipulate the lock 56 between the first position and the second position. The switching unit 52 includes a lever 64 which has a coupled end 66 that is coupled to the lock 56 such that the lever 64 is positioned in the switch space 24 between the top wall 20 of the battery 12 and the dividing wall 22 of the battery 12.

The lever 64 has a free end 68 and the free end 68 is positioned in the contact space 41 between the first housing 26 and the second housing 34 when the lock 56 is positioned in first position. The free end 68 is displaced from the contact space 41 when the lock 56 is positioned in the second position. A switch contact 70 is integrated into the lever 64 at a point located adjacent to the free end 68 of the lever 64 and the switch contact 70 is comprised of an electrically conductive material. The switch contact 70 engages each of the first contact 44 and the second contact 48 when the lock 56 is positioned in the first position. In this way electrical communication is facilitated between the negative terminal 16 and the plurality of chemical cells 18 to complete a circuit between the positive terminal 14 and the negative terminal 16.

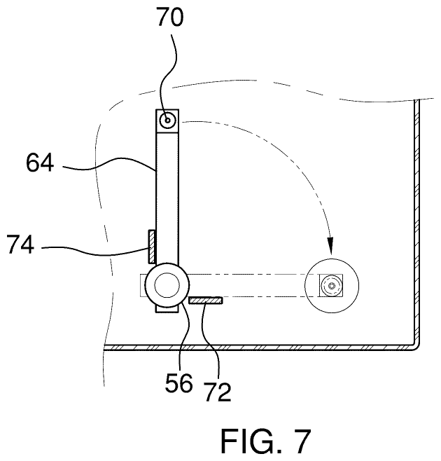

As is most clearly shown in FIG. 7, a first stop 72 is integrated into the top wall 20 of the battery 12 and a second stop 74 is integrated into the top wall 20 of the battery 12. The first stop 72 is positioned such that the lever 64 abuts the first stop 72 when the lock 56 is in the first position to inhibit the lever 64 from moving beyond the first contact 44 and the second contact 48. The second stop 74 is positioned such that the lever 64 abuts the second stop 74 when the lock 56 is in the second position to inhibit the lever 64 from moving beyond a desired point of rotation.

In use, the battery 12 is installed in the vehicle and each of a positive cable 76 and a negative cable 78 of the vehicle are coupled to a respective positive terminal 14 and negative terminal 16 on the battery 12. The key 62 is inserted into the lock 56 to facilitate the lock 56 to be positioned in the first position thereby completing the circuit between the positive terminal 14 and the negative terminal 16 on the battery 12. In this way the battery 12 can supply electrical current to the vehicle for starting the vehicle. The key 62 is inserted into the lock 56 to facilitate the lock 56 to be positioned in the second position thereby breaking the circuit between the positive terminal 14 and the negative terminal 16 on the battery 12. In this way the battery 12 is inhibited from supplying electrical current to the vehicle. Thus, the battery 12 will not become inadvertently discharged due to an electrical malfunction in the vehicle as well as inhibiting the vehicle from being stolen.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A switchable battery assembly being actuatable between a live position and a dead position, said assembly comprising:
a battery having a positive terminal and a negative terminal and a plurality of chemical cells positioned within said battery, said positive terminal being in continuous electrical communication with said plurality of chemical cells, said negative terminal being inhibited from being in electrical communication with said plurality of chemical cells; and
a switching unit being movably integrated into said battery, said switching unit being positionable in an on position thereby facilitating electrical communication between said negative terminal and said plurality of chemical cells thereby actuating said battery into a live condition wherein said battery is configured to supply electrical current to an electrical circuit, said switching unit being positionable in an off position thereby inhibiting electrical communication between said negative terminal and said plurality of chemical cells thereby actuating said battery into a dead condition wherein said battery is configured to be inhibited from supplying electrical current to the electrical circuit.

2. The assembly according to claim 1, wherein:
said battery has a top wall, each of said positive terminal and said negative terminal being disposed on said top wall;
said battery has a dividing wall being spaced from said top wall to define a switch space between said dividing wall and said top wall, each of said chemical cells being positioned beneath said dividing wall;
said battery has a first housing being integrated into a bottom surface of said top wall, said first housing having an outer wall extending downwardly from said bottom surface and a lower wall being spaced from said bottom surface;
said battery has a second housing being integrated into a top surface of said dividing wall, said second housing having an exterior wall extending upwardly from said top surface and an upper wall being spaced from said top surface; and
said first housing is aligned with said second housing to define a contact space between said lower wall of said first housing and said upper wall of said second housing.

3. The assembly according to claim 2, further comprising:
a first contact being movably integrated into said lower wall of said first housing, said first contact being comprised of an electrically conductive material; and
a first spring being positioned within said first housing, said first spring extending between said negative terminal and said first contact, said first spring being comprised of an electrically conductive material thereby facilitating electrical communication between said first contact and said negative terminal, said first spring biasing said first contact away from said negative terminal.

4. The assembly according to claim 3, further comprising:
a negative contact being electrically coupled to a respective one of said plurality of chemical cells, said negative contact extending through said dividing wall, said negative contact being comprised of an electrically conductive material;
a second contact being movably integrated into said upper wall of said second housing, said second contact being comprised of an electrically conductive material; and
a second spring being positioned within said second housing, said second spring extending between said negative contact associated with said plurality of chemical cells and said second contact, said second spring being comprised of an electrically conductive material thereby facilitating electrical communication between said second contact and said negative contact associated with said plurality of chemical cells, said second spring biasing said second contact away from said negative contact associated with said plurality of chemical cells.

5. The assembly according to claim 2, wherein said switching unit comprises a lock being movably integrated into said top wall of said battery, said lock having an exposed surface with respect to said top wall, said lock having a keyhole being integrated into said exposed surface thereby facilitating said keyhole to insertably receive a key for rotating said lock between a first position and a second position.

6. The assembly according to claim 5, wherein said switching unit includes a lever having a coupled end being coupled to said lock such that said lever is positioned in said switch space between said top wall of said battery and said dividing wall of said battery, said lever having a free end, said free end being positioned in said contact space between said first housing and said second housing when said lock is positioned in first position, said free end being displaced from said contact space when said lock is positioned in said second position.

7. The assembly according to claim 6, further comprising:
a first contact being integrated into said first housing;
a second contact being integrated into said second housing:
a negative contact being integrated into said dividing wall having said negative contact being in electrical communication with respective one of said plurality of chemical cells; and
a switch contact being integrated into said lever at a point located adjacent to said free end of said lever, said switch contact being comprised of an electrically conductive material, said switch contact engaging each of said first contact and said second contact when said lock is positioned in said first position thereby facilitating electrical communication between said negative terminal and said plurality of chemical cells to complete a circuit between said positive terminal and said negative terminal.

8. A switchable battery assembly being actuatable between a live position and a dead position, said assembly comprising:
a battery having a positive terminal and a negative terminal and a plurality of chemical cells positioned within said battery, said positive terminal being in continuous electrical communication with said plurality of chemical cells, said negative terminal being inhibited from being in electrical communication with said plurality of chemical cells, said battery having a top wall, each of said positive terminal and said negative terminal being disposed on said top wall, said battery having a dividing wall being spaced from said top wall to define a switch space between said dividing wall and said top wall, each of said chemical cells being positioned beneath said dividing wall, said battery having a first housing being integrated into a bottom surface of said top wall, said first housing having an outer wall extending downwardly from said bottom surface and a lower wall being spaced from said bottom surface, said battery having a second housing being integrated into a top surface of said dividing wall, said second housing having an exterior wall extending upwardly from said top surface and an upper wall being spaced from said top surface, said first housing being aligned with said second housing to define a contact space between said lower wall of said first housing and said upper wall of said second housing;
a negative contact being electrically coupled to a respective one of said plurality of chemical cells, said negative contact extending through said dividing wall, said negative contact being comprised of an electrically conductive material;
a first contact being movably integrated into said lower wall of said first housing,
said first contact being comprised of an electrically conductive material;
a first spring being positioned within said first housing, said first spring extending between said negative terminal and said first contact, said first spring being comprised of an electrically conductive material thereby facilitating electrical communication between said first contact and said negative terminal, said first spring biasing said first contact away from said negative terminal;
a second contact being movably integrated into said upper wall of said second housing, said second contact being comprised of an electrically conductive material;
a second spring being positioned within said second housing, said second spring extending between said negative contact associated with said plurality of chemical cells and said second contact, said second spring being comprised of an electrically conductive material thereby facilitating electrical communication between said second contact and said negative contact associated with said plurality of chemical cells, said second spring biasing said second contact away from said negative contact associated with said plurality of chemical cells; and
a switching unit being movably integrated into said battery, said switching unit being positionable in an on position thereby facilitating electrical communication between said negative terminal and said plurality of chemical cells thereby actuating said battery into a live condition wherein said battery is configured to supply electrical current to an electrical circuit, said switching unit being positionable in an off position thereby inhibiting electrical communication between said negative terminal and said plurality of chemical cells thereby actuating said battery into a dead condition wherein said battery is configured to be inhibited from supplying electrical current to the electrical circuit, said switching unit comprising:
a lock being movably integrated into said top wall of said battery, said lock having an exposed surface with respect to said top wall, said lock having a keyhole being integrated into said exposed surface thereby facilitating said keyhole to insertably receive a key for rotating said lock between a first position and a second position;
a lever having a coupled end being coupled to said lock such that said lever is positioned in said switch space between said top wall of said battery and said dividing wall of said battery, said lever having a free end, said free end being positioned in said contact space between said first housing and said second housing when said lock is positioned in first position, said free end being displaced from said contact space when said lock is positioned in said second position; and
a switch contact being integrated into said lever at a point located adjacent to said free end of said lever, said switch contact being comprised of an electrically conductive material, said switch contact engaging each of said first contact and said second contact when said lock is positioned in said first position thereby facilitating electrical communication between said negative terminal and said plurality of chemical cells to complete a circuit between said positive terminal and said negative terminal.
